(19) United States
(12) Patent Application Publication
(10) Pub. No.: US 2025/0368049 A1
(43) Pub. Date: Dec. 4, 2025

(54) TRAIN SET

(71) Applicant: KAWASAKI RAILCAR MANUFACTURING CO., LTD., Kobe-shi, Hyogo (JP)

(72) Inventors: Keisuke TAKAHASHI, Kobe-shi, Hyogo (JP); Go TATEISHI, Kobe-shi, Hyogo (JP); Masato OTA, Kobe-shi, Hyogo (JP)

(73) Assignee: KAWASAKI RAILCAR MANUFACTURING CO., LTD., Kobe-shi, Hyogo (JP)

(21) Appl. No.: 18/867,452

(22) PCT Filed: May 23, 2022
(86) PCT No.: PCT/JP2022/021109

§ 371 Date: Nov. 20, 2024

(51) Int. Cl. B60L 3/04; B60L 15/32

(52) U.S. Cl. CPC B60L 3/04; B60L 15/32; B60L 2200/26

(57) ABSTRACT

A train set includes: an electric power bus line extending through cars; and circuit breaking equipment that is located in an attic space between a roof and ceiling of a car end portion of at least one middle car included in the cars and interrupts a current flowing through the electric power bus line. The circuit breaking equipment includes: a first connector that is electrically connected to the electric power bus line located at the middle car and includes a first electric power terminal; a second connector that is electrically connected to the electric power bus line located at a car adjacent to the middle car among the cars and includes a second electric power terminal; and a circuit breaker located between the first electric power terminal and the second electric power terminal.

### TECHNICAL FIELD

The present disclosure relates to a train set including cars coupled to each other.

### BACKGROUND ART

PTL 1 discloses a train set including cars coupled to each other. The adjacent cars are electrically connected to each other by a high-voltage pull-through cable. A circuit breaker that cuts off electrical connection between the adjacent cars is located on the high-voltage pull-through cable. In PTL 1, an apparatus box accommodating the circuit breaker is located under the floor of a car body such that a worker can perform electrical separation between the adjacent cars without getting on a roof of the car.

### CITATION LIST

### Patent Literature

PTL 1: Japanese Laid-Open Patent Application Publication No. 2009-136142

### SUMMARY OF INVENTION

### Technical Problem

However, when locating the circuit breaker under the floor of the car body, a member that suspends the circuit breaker from the car body and a member that protects the circuit breaker are required. This increases the number of parts, and therefore, increases the weight of the car. Moreover, when locating the circuit breaker on the roof, the circuit breaker disturbs air flow during high-speed traveling, and this generates wind noise. Furthermore, when locating the circuit breaker at an outside of the car body, this impairs the appearance of the car.

An object of one aspect of the present disclosure is to achieve a car weight reduction, a noise reduction, and an appearance improvement.

### Solution to Problem

A train set according to one aspect of the present disclosure a train set including: cars coupled to each other; an electric power bus line extending through the cars; and circuit breaking equipment that is located in an attic space between a roof and ceiling of a car end portion of at least one middle car included in the cars and interrupts a current flowing through the electric power bus line. The circuit breaking equipment includes: a first connector that is electrically connected to the electric power bus line located at the middle car and includes a first electric power terminal; a second connector that is electrically connected to the electric power bus line located at a car adjacent to the middle car among the cars and includes a second electric power terminal; and a circuit breaker located between the first electric power terminal and the second electric power terminal.

### Advantageous Effects of Invention

According to one aspect of the present disclosure, the members that suspend and protect the circuit breaking equipment can be omitted as compared to when the circuit breaking equipment is located under the floor, and the wind noise during the high-speed traveling can be reduced and the appearance improves as compared to when the circuit breaking equipment is located on the roof so as to be exposed. Therefore, the car weight reduction, the noise reduction, and the appearance improvement can be achieved.

### BRIEF DESCRIPTION OF DRAWINGS

FIG. 1 is a side view schematically showing a train set according to Embodiment 1.

FIG. 2 is a schematic diagram showing an electric system of the train set of FIG. 1.

FIG. 3 is a plan view of high-voltage circuit breaking equipment of FIG. 1.

FIG. 4 is a sectional view showing a connector and a cable connector in the high-voltage circuit breaking equipment of FIG. 3.

FIG. 5 is a schematic diagram showing the high-voltage circuit breaking equipment of the train set of FIG. 1 and its vicinity.

FIG. 6 is a side view schematically showing the train set including a circuit of FIG. 5.

FIG. 7 is a side view schematically showing the train set according to Embodiment 2.

FIG. 8 is a schematic diagram showing the electric system of the train set of FIG. 7.

FIG. 9 is a plan view of the high-voltage circuit breaking equipment of FIG. 7.

### DESCRIPTION OF EMBODIMENTS

Hereinafter, embodiments will be described with reference to the drawings.

### Embodiment 1

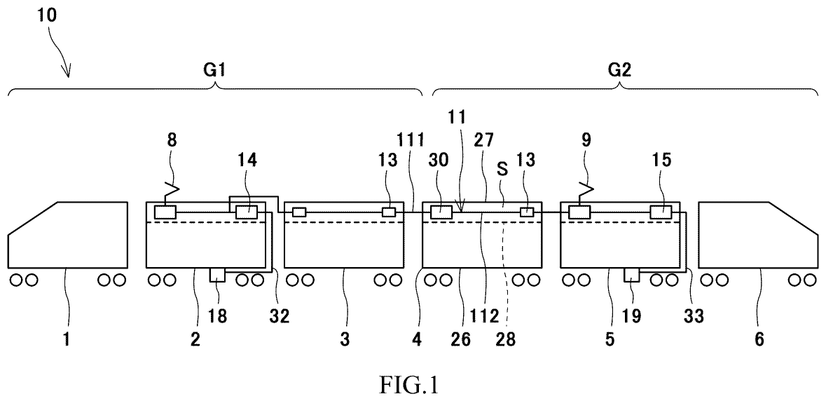

FIG. 1 is a side view schematically showing a train set 10 according to Embodiment 1. As shown in FIG. 1, a railcar 1 is a train set including cars 1 to 6 coupled to each other. As one example, the present embodiment describes a train set including six cars, but the number of cars is not limited to this. Middle cars 2 to 5 are located between end cars 1 and 6 (also called head cars) located at both ends of the train set 10 in a car longitudinal direction. In an example of FIG. 1, the end cars 1 and 6 are respectively a first car and a sixth car. A pantograph 8 is mounted on a roof of the middle car 2 that is a second car. A pantograph 9 is mounted on the middle car 5 that is a fifth car. The middle cars 2 and 5 that are the second and fifth cars are driving cars. The middle car 2 includes a main transformer 18 located under the floor thereof. The middle car 5 includes a main transformer 19 located under the floor thereof. The positions of apparatuses, such as the pantographs and the main transformers, are not limited to these.

Each of car bodies 26 of the middle cars 2 to 6 includes: a roof 27; a ceiling 28 located under the roof 27; and an attic space S located between the roof 27 and the ceiling 28. An electric power bus line 11 electrically connected to the pantographs 8 and 9 extends through the cars 2 to 6. Since the voltage (25 kV, for example) of the current flowing through the electric power bus line 11 is higher than 7,000 V, the electric power bus line 11 is also called a high-voltage bus line. In the present embodiment, the current flowing through the electric power bus line 11 is an alternating current, but may be a direct current.

At least a part of the electric power bus line 11 is located in the attic space S. In the present embodiment, the entire electric power bus line 11 except for portions located between the adjacent cars is located in the attic spaces S. High-voltage circuit breaking equipment 30 (first circuit breaking equipment) that interrupts the current flowing through the electric power bus line 11 is located in the attic space S of the middle car 4. Main transformer circuit breaking equipment 14 (second circuit breaking equipment) and main transformer circuit breaking equipment 15 (second circuit breaking equipment) are respectively located in the attic spaces S of the middle cars 2 and 6. Each of the structure of the main transformer circuit breaking equipment 14 and the structure of the main transformer circuit breaking equipment 15 is the same as the structure of the high-voltage circuit breaking equipment 30.

The electric power bus line 11 includes a coupling electric power cable 111 extending between the middle car 3 as a third car and the middle car 4 as a fourth car. The coupling electric power cable 111 is coupled to a straight joint 13 and the high-voltage circuit breaking equipment 30. The straight joint 13 is located at a car end portion of the middle car 3 which is opposed to the middle car 4, and the high-voltage circuit breaking equipment 30 is located at a car end portion of the middle car 4 which is opposed to the middle car 3. A car electric power cable 112 is also coupled to the high-voltage circuit breaking equipment 30. The car electric power cable 112 extends in the attic space S of the middle car 4 toward the middle car 5.

The high-voltage circuit breaking equipment 30 also serves as a joint located between the coupling electric power cable 111 and the car electric power cable 112. The train set 10 includes: first electric power system equipment G1 including the pantograph 8; and second electric power system equipment G2 including the pantograph 9. These two pieces of electric power system equipment G1 and G2 are connected to each other by the high-voltage circuit breaking equipment 30.

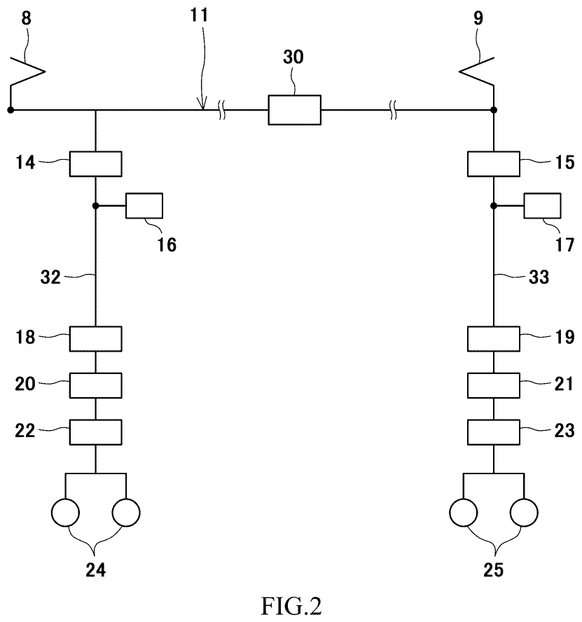

FIG. 2 is a schematic diagram showing an electric system of the train set 10 of FIG. 1. As shown in FIG. 2, the high-voltage circuit breaking equipment 30 is located between a portion of the electric power bus line 11 which is connected to the pantograph 8 and a portion of the electric power bus line 11 which is connected to the pantograph 9. The main transformer 18, a converter 20, an inverter 22, and a traction motor 24 are located under the floor of the middle car 2. The main transformer 19, a converter 21, an inverter 23, and a traction motor 25 are located under the floor of the middle car 6. The main transformers 18 and 19, the converters 20 and 21, and the inverters 22 and 23 are examples of underfloor equipment. Each of the traction motors 24 and 25 is mounted on a bogie to drive a wheelset.

In the middle car 2, an electric power supply circuit 32 is branched from the electric power bus line 11. In the middle car 6, an electric power supply circuit 33 is branched from the electric power bus line 11. The electric power supply circuit 32 is a circuit that connects the electric power bus line 11 to the main transformer 18. The electric power supply circuit 33 is a circuit that connects the electric power bus line 11 to the main transformer 19. The main transformer circuit breaking equipment 14 that can interrupt the current flowing from the electric power bus line 11 toward the main transformer 18 is located at the electric power supply circuit 32. The main transformer circuit breaking equipment 15 that can interrupt the current flowing from the electric power bus line 11 toward the main transformer 19 is located at the electric power supply circuit 33.

The alternating current whose voltage has been lowered by the main transformer 18 is converted into the direct current by the converter 20. The alternating current whose voltage has been lowered by the main transformer 19 is converted into the direct current by the converter 21. The converted direct currents are converted into alternating currents by the inverters 22 and 23. The converted alternating currents are supplied to the traction motors 24 and 25. A main transformer is not mounted on each of the middle cars 3 to 5, but a converter, an inverter, and a traction motor may be mounted on each of the middle cars 3 to 5. When the current flowing through the electric power bus line 11 is a direct current, the converters 20 and 21 are unnecessary.

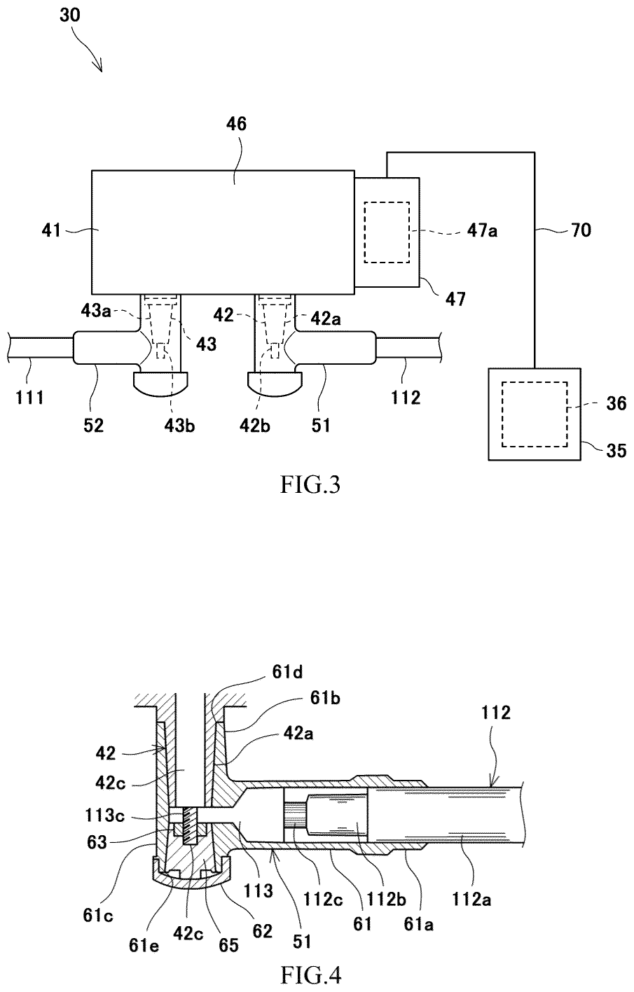

FIG. 3 is a plan view of the high-voltage circuit breaking equipment 30 of FIG. 1. As shown in FIG. 3, the high-voltage circuit breaking equipment 30 includes a circuit breaker 41, a first connector 42, a second connector 43, and a third connector 44. The connectors 42 to 44 project from the circuit breaker 41 toward a lateral side. The first connector 42 includes: a first housing 42a made of an insulator having a substantially conical shape that decreases in diameter toward a tip thereof; and a first electric power terminal 42b that projects beyond the tip of the first housing 42a. The second connector 43 includes: a second housing 43a made of an insulator having a substantially conical shape that decreases in diameter toward a tip thereof; and a second electric power terminal 43b that projects beyond the tip of the second housing 43a. The third connector 44 includes: a third housing 44a made of an insulator having a substantially conical shape that decreases in diameter toward a tip thereof; and a third electric power terminal 44b that projects beyond the tip of the third housing 44a.

The circuit breaker 41 is, for example, a vacuum circuit breaker (VCB) including an internal circuit that can open and close. The circuit breaker 41 is located between the first electric power terminal 42b and the second electric power terminal 43b. To be specific, the circuit breaker 41 can open and close a circuit between the first electric power terminal 42b and the second electric power terminal 43b.

The circuit breaker 41 includes a breaker main body 46 and an actuator 47. The breaker main body 46 includes an internal circuit that can open and close the circuit between the first electric power terminal 42b and the second electric power terminal 43b. The actuator 47 includes a drive circuit 47a that electromagnetically drives the breaker main body 46 so as to open and close the internal circuit of the breaker main body 46. When the drive circuit 47a is supplied with electric power from a controller 35 through an output control line 70, the drive circuit 47a sets the breaker main body 46 to a closed state. When the supply of the electric power from the controller 35 through the output control line 70 stops, the drive circuit 47a sets the breaker main body 46 to an open state. To be specific, the circuit breaker 41 is set to be normally open.

A first cable connector 51 is attached to a tip portion of the car electric power cable 112. A second cable connector 52 is attached to a tip portion of the coupling electric power cable 111. When the first cable connector 51 is connected to the first connector 42, a terminal of the car electric power cable 112 is brought into conduction with the first electric power terminal 42b of the high-voltage circuit breaking equipment 30. When the second cable connector 52 is connected to the second connector 43, a terminal of the coupling electric power cable 111 is brought into conduction with the second electric power terminal 43b of the high-voltage circuit breaking equipment 30. To be specific, the first electric power terminal 42b is electrically connected to a portion of the electric power bus line 11 which is located at the middle car 4, and the second electric power terminal 43b is electrically connected to a portion of the electric power bus line 11 which extends from the middle car 4 toward the middle car 3 located adjacent to the middle car 4.

FIG. 4 is a sectional view showing the first connector 42 and the first cable connector 51 in the high-voltage circuit breaking equipment 30 of FIG. 3. As shown in FIG. 4, the first connector 42 includes a conductor 42c that is located inside the first housing 42a having a tapered shape and is connected to the internal circuit of the circuit breaker 41. The first electric power terminal 42b that is a bolt is fixed to a tip of the conductor 42c. The first electric power terminal 42b projects to an outside of the housing 42a so as to be exposed from the housing 42a.

The first cable connector 51 includes a housing 61 made of an elastic insulating material and having a T shape. The housing 61 includes a base tube portion 61a, a fitting tube portion 61b, and a work tube portion 61c. A tip portion of the car electric power cable 112 is inserted into the base tube portion 61a. The fitting tube portion 61b is continuous with the base tube portion 61a so as to be substantially orthogonal to the base tube portion 61a and includes a fitting opening 61d at a tip thereof. The work tube portion 61c is substantially orthogonal to the base tube portion 61a and projects in an opposite direction to the fitting tube portion 61b on substantially the same straight line as the fitting tube portion 61b. Internal spaces of the tube portions 61a to 61c communicate with each other and have a T shape as a whole.

The housing 61 includes the fitting opening 61d such that a direction substantially orthogonal to a length direction of the car electric power cable 112 corresponds to a fitting direction. An inner peripheral surface of the fitting tube portion 61b has a substantially conical shape corresponding to an outer shape of the housing 42a of the first connector 42. The work tube portion 61c includes a work opening 61e that is open toward an opposite side of the fitting opening 61d.

At a tip portion of the car electric power cable 112, a cover 112a is stripped off, and therefore, a cable insulator 112b is exposed. A cable conductor 112c is exposed from a tip of the cable insulator 112b, and a cable terminal 122 is coupled to the cable conductor 112c. A tip portion of the cable terminal 122 includes a connection hole 122a. The cable terminal 122 is located inside the housing 61. A base end portion of the cable terminal 122 which is crimped to the cable conductor 112c has a tubular shape, and the tip portion of the cable terminal 122 at which the connection hole 122a is located has a plate shape. An end portion of the car electric power cable 112 and the cable terminal 122 are inserted into the base tube portion 61a of the housing 61. A tip portion of the cable terminal 122 is exposed to an internal space of the fitting tube portion 61b of the housing 61, and a center of the connection hole 122a of the cable terminal 122 substantially coincides with a center of the internal space of the fitting tube portion 61b.

When the fitting tube portion 61b of the first cable connector 51 is fitted to the first connector 42 of the high-voltage circuit breaking equipment 30, the first electric power terminal 42b is inserted into the connection hole 122a of the cable terminal 122. The cable terminal 122 and the first electric power terminal 42b are connected to each other in such a manner that a nut 63 is fastened through the work opening 61e to a portion of the first electric power terminal 42b which projects from the connection hole 122a. The work opening 61e is filled with an insulating plug 65 and is closed by a cap 62.

Since each of the structures of the second connector 43 and the third connector 44 is the same as the structure of the first connector 42, and each of the structures of the second cable connector 52 and a lightning arrester connector 53 is the same as the structure of the first cable connector 51, explanations thereof are omitted.

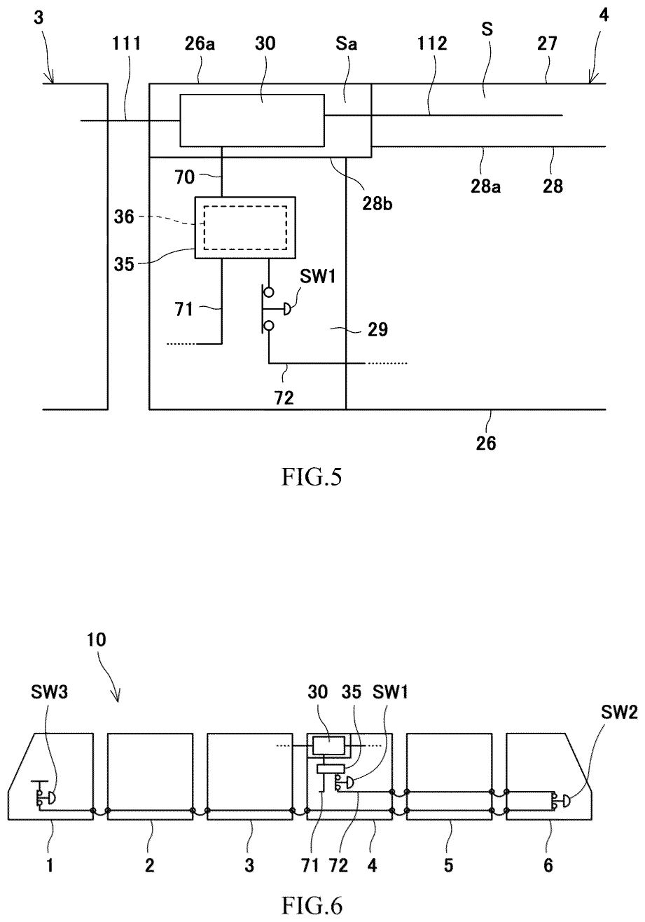

FIG. 5 is a schematic diagram showing the high-voltage circuit breaking equipment 30 of the train set 10 of FIG. 1 and its vicinity. As shown in FIG. 5, the ceiling 28 of the middle car 4 includes: a first ceiling 28a located above a passenger room; and a second ceiling 28b that is located at a car end portion 26a of the car body 26 and lower than the first ceiling 28a. The high-voltage circuit breaking equipment 30 is located in an attic space Sa located at an upper side of the second ceiling 28b. An electric power distribution room 29 is located under the second ceiling 28b. The car electric power cable 112 extends through the attic space S located above the first ceiling 28a but may extend through an upper side of the roof 27.

The controller 35 including control circuitry 36 is located in the electric power distribution room 29. The control circuitry 36 is electrically connected to the high-voltage circuit breaking equipment 30 through a power supply line 70. A power supply line 71 of the train set 1 is connected to the control circuitry 36. The control circuitry 36 can supply electric power, supplied from the power supply line 71, to the high-voltage circuit breaking equipment 30 through the output control line 70. An input control line 72 is connected to the control circuitry 36.

When the control circuitry 36 is supplied with electric power from the power supply line 71 and receives a connection command from the input control line 72, the control circuitry 36 supplies the electric power, supplied from the power supply line 71, to the high-voltage circuit breaking equipment 30 through the output control line 70. When the supply of the electric power from the power supply line 71 to the control circuitry 36 stops, or when the control circuitry 36 receives an interruption command from the input control line 72, the control circuitry 36 stops the supply of the electric power to the high-voltage circuit breaking equipment 30. As one example, the connection command is the electric power supply from the control line 72 to the control circuitry 36, and the interruption command is the stop of the electric power supply from the control line 72 to the control circuitry 36.

FIG. 6 is a side view schematically showing the train set 10 including the circuit of FIG. 5. As shown in FIG. 6, the input control line 72 extends in series from the middle car 4 through the end car 6 to the end car 1 and is connected to a power supply. A first operation switch SW1, a second operation switch SW2, and a third operation switch S3 are located in series on the input control line 72. The first operation switch SW1 is located in an inside of the middle car 4 on which the controller 35 is mounted. The second operation switch SW2 is located in an inside of the end car 6, and for example, located in a driver's cab. The third operation switch SW3 is located in an inside of the end car 1, and for example, located in the driver's cab. The first to third operation switches SW1 to SW3 are manually operated by a human.

When all of the first to third operation switches SW1 to SW3 are set to an ON state (closed state), a current flows from the input control line 72 to the control circuitry 36. When the control circuitry 36 receives the supply of the electric power from the input control line 72, the control circuitry 36 outputs a connection signal, which sets the high-voltage circuit breaking equipment 30 to the closed state, to the high-voltage circuit breaking equipment 30 through the output control line 70. To be specific, the supply of the electric power from the input control line 72 to the control circuitry 36 serves as the connection command that sets the high-voltage circuit breaking equipment 30 to the closed state. Moreover, the supply of the electric power from the output control line 70 to the circuit breaking equipment 30 denotes the connection signal from the control circuitry 36 to the circuit breaking equipment 30.

When any one of the first to third operation switches SW1 to SW3 is set to an OFF state (open state), the current does not flow from the input control line 72 to the control circuitry 36. When the supply of the electric power from the input control line 72 stops, the control circuitry 36 outputs an interruption signal, which sets the high-voltage circuit breaking equipment 30 to the open state, to the high-voltage circuit breaking equipment 30 through the output control line 70. To be specific, the stop of the supply of the electric power from the input control line 72 to the control circuitry 36 serves as the interruption command that sets the high-voltage circuit breaking equipment 30 to the open state. Moreover, the stop of the supply of the electric power from the output control line 70 to the circuit breaking equipment 30 denotes the interruption signal from the control circuitry 36 to the circuit breaking equipment 30.

A worker or a crew member can manually operate the operation switch SW1 in the inside of the middle car 4 to operate the high-voltage circuit breaking equipment 30 without getting on the roof 27 or getting under the floor to directly access the high-voltage circuit breaking equipment 30. The position of the operation switch SW1 is not limited to the inside of the car and may be, for example, under the floor of the car body 26.

According to the above-described configuration, members that suspend and protect the high-voltage circuit breaking equipment 30 can be omitted as compared to when the high-voltage circuit breaking equipment 30 is located under the floor, and wind noise during high-speed traveling can be reduced and appearance improves as compared to when the high-voltage circuit breaking equipment 30 is located on the roof so as to be exposed. Therefore, the car weight reduction, the noise reduction, and the appearance improvement can be achieved.

When electric power is supplied to the drive circuit 47a, the breaker main body 46 is set to the closed state. When the supply of the electric power to the drive circuit 47a stops, the breaker main body 46 is set to the open state. Therefore, when the supply of the electric power to the drive circuit 47a stops due to the occurrence of abnormality, the circuit breaker 41 is set to the open state, and this can improve the safety.

Since the circuit breaker 41 operates by a command generated by operating any one of the first to third operation switches SW1 to SW3 located in the inside of the car, the worker or the crew member does not work on the roof or under the floor. Thus, the workload can be significantly reduced, and the safety of the work improves.

Since the first to third operation switches SW1 to SW3 are located in series on the input control line 72 extending from the end cars 1 and 6 to the middle car 4, the circuit breaker 41 can be operated at a convenient place while simplifying the configuration.

Since each of the main transformer circuit breaking equipment 14 for the main transformer 18 and the main transformer circuit breaking equipment 15 for the main transformer 19 is also located in the attic space S, the car weight reduction, the noise reduction, and the appearance improvement can be further satisfactorily achieved.

### Embodiment 2

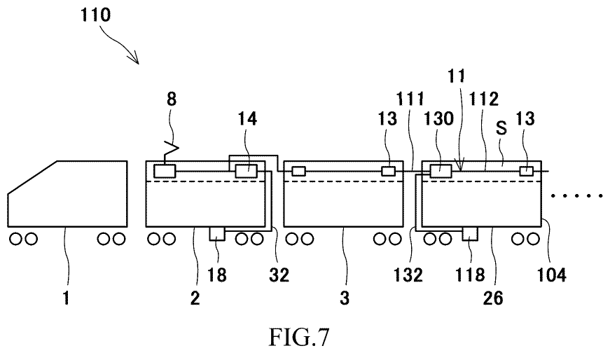

FIG. 7 is a side view schematically showing a train set 110 according to Embodiment 2. The same reference signs are used for the same components as Embodiment 1, and explanations thereof are omitted. As shown in FIG. 7, in the train set 110 of Embodiment 2, a main transformer 118 is located under a floor of a middle car 104 on which a high-voltage circuit breaking equipment 130 is mounted. An electric power supply circuit 132 that supplies electric power from the electric power bus line 11 to the main transformer 118 as the underfloor equipment is connected to the high-voltage circuit breaking equipment 130. To be specific, in the high-voltage circuit breaking equipment 130, a circuit branches in three directions including two directions of the electric power bus line 11 and one direction of the electric power supply circuit 132.

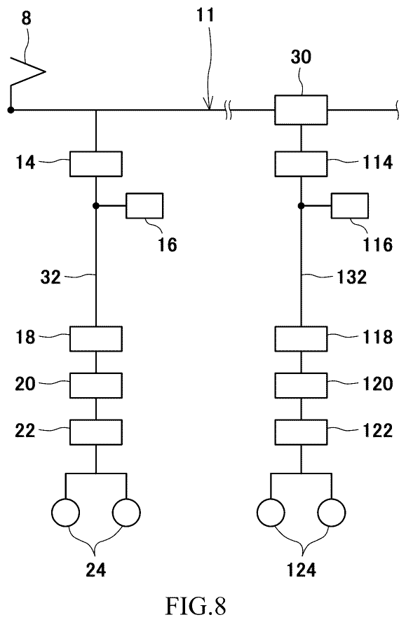

FIG. 8 is a schematic diagram showing an electric system of the train set 110 of FIG. 7. As shown in FIG. 8, the main transformer 118, a converter 120, an inverter 122, and a traction motor 124 are located under the floor of the middle car 104. The electric power supply circuit 132 is branched from the electric power bus line 11 in the middle car 104. The electric power supply circuit 132 connects the electric power bus line 11 to the main transformer 118. Main transformer circuit breaking equipment 114 that interrupts the current flowing from the electric power bus line 11 toward the main transformer 118 is located at the electric power supply circuit 132.

The alternating current whose voltage has been lowered by the main transformer 118 is converted into the direct current by the converter 120. This direct current is converted into the alternating current by the inverter 122. This alternating current is supplied to the traction motor 124. Although the main transformer circuit breaking equipment 114 is not shown in FIG. 7, the main transformer circuit breaking equipment 114 may be located in the attic space S together with the high-voltage circuit breaking equipment 30. However, the main transformer circuit breaking equipment 114 may be located under the floor.

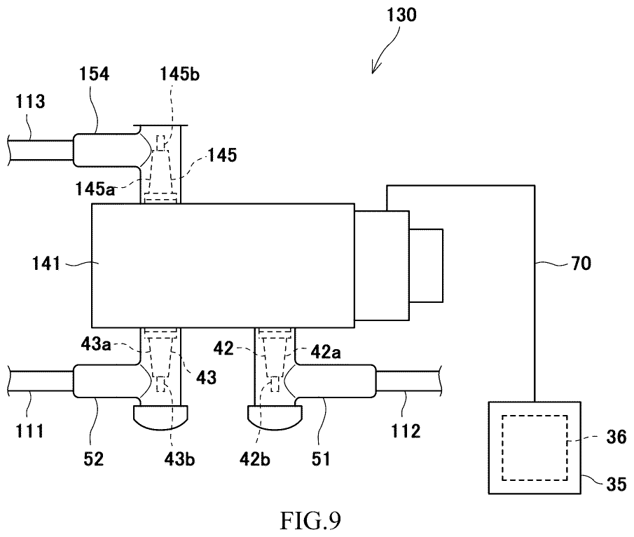

FIG. 9 is a plan view of the high-voltage circuit breaking equipment 130 of FIG. 7. As shown in FIG. 9, the number of connectors in the high-voltage circuit breaking equipment 130 of Embodiment 2 is larger than that in the high-voltage circuit breaking equipment 30 of Embodiment 1. For convenience sake, the third connector 44 of Embodiment 1 is referred to as a fourth connector, and a newly added connector 145 is referred to as a third connector. The configuration of the third connector 145 is the same as each of the first and second connectors 42 and 43. The third connector 145 includes: a third housing 145a made of an insulator having a substantially conical shape that decreases in diameter toward a tip thereof; and a third electric power terminal 145b that projects beyond the tip of the third housing 145a. The circuit breaker 141 can break the circuit between the first electric power terminal 42b and the second electric power terminal 43b and brings the third electric power terminal 145b into conduction with the first electric power terminal 42b or the second electric power terminal 43b.

An electric power supply cable 113 constituting the electric power supply circuit 132 (see FIG. 7) is connected to the third connector 145. A third cable connector 154 is attached to a tip portion of the electric power supply cable 113. The configuration of the third cable connector 154 is the same as the configuration of the first cable connector 51. When the third cable connector 154 is connected to the third connector 145, a conductor of the electric power supply cable 113 is brought into electrical conduction with the third electric power terminal 145b of the third connector 145 of the high-voltage circuit breaking equipment 30.

According to this configuration, since the high-voltage circuit breaking equipment 130 serves as a three-branch joint, and therefore, an additional joint is not required, the degree of freedom of the arrangement of on-vehicle parts can be improved. Since the other components are the same as those in Embodiment 1, explanations thereof are omitted.

The foregoing has described the embodiments as examples of the technology disclosed in the present application. However, the technology in the present disclosure is not limited to these and is applicable to embodiments in which modifications, replacements, additions, omissions, and the like have been suitably made. Moreover, a new embodiment may be prepared by combining the components described in the above embodiments. For example, some of components or methods in one embodiment may be applied to another embodiment. Some components in an embodiment may be separated from the other components in the embodiment and arbitrarily extracted. Furthermore, the components shown in the attached drawings and the detailed explanations include not only components essential to solve the problems but also components for exemplifying the above technology and not essential to solve the problems.

### Reference Signs List

2 to 6, 104 middle car
10, 110 train set
11 electric power bus line
14, 15, 114 main transformer circuit breaking equipment (second circuit breaking equipment)
18, 19, 118 main transformer (underfloor equipment)
26 car body
26a car end portion
27 roof
28 ceiling
30, 130 high-voltage circuit breaking equipment (first circuit breaking equipment)
36 control circuitry
41 circuit breaker
42 first connector
42b first electric power terminal
43 second connector
43b second electric power terminal
44 third connector
44b third electric power terminal
46 breaker main body
47 actuator
47a drive circuit
70 output control line
71 power supply line
72 input control line
132 electric power supply circuit
145 third connector
145b third electric power terminal
S, Sa attic space
SW operation switch

1. A train set comprising:
cars coupled to each other;
an electric power bus line extending through the cars; and
circuit breaking equipment that is located in an attic space between a roof and ceiling of a car end portion of at least one middle car included in the cars and interrupts a current flowing through the electric power bus line, wherein
the circuit breaking equipment includes
a first connector that is electrically connected to the electric power bus line located at the middle car and includes a first electric power terminal,
a second connector that is electrically connected to the electric power bus line located at a car adjacent to the middle car among the cars and includes a second electric power terminal, and
a circuit breaker located between the first electric power terminal and the second electric power terminal.

2. The train set according to claim 1, wherein:
the circuit breaker includes
a breaker main body that opens and closes a circuit between the first electric power terminal and the second electric power terminal and
a drive circuit that drives the breaker main body;
when the drive circuit is supplied with electric power, the drive circuit sets the breaker main body to a closed state; and
when the supply of the electric power to the drive circuit stops, the drive circuit sets the breaker main body to an open state.

3. The train set according to claim 1, further comprising an operation switch located in an inside of at least one of the cars; and
the circuit breaker operates by a command signal from the operation switch.

4. The train set according to claim 3, wherein:
the operation switch includes a first operation switch;
the train set further includes a second operation switch located in an inside of an end car included in the cars;
the middle car further includes control circuitry to which a control line is connected and which is connected to the circuit breaker through an output control line;
the input control line extends from the end car to the middle car;
the first operation switch and the second operation switch are located on the input control line in series; and
when the control circuitry receives from the input control line an interruption command generated by operating the first operation switch or the second operation switch, the control circuitry outputs an interruption signal that sets the circuit breaker to an open state.

5. The train set according to claim 1, further comprising an electric power supply circuit that supplies electric power from the electric power bus line to underfloor equipment, wherein
the circuit breaking equipment further includes a third connector which is electrically connected to the electric power supply circuit and is integrally connected to a third electric power terminal.

6. The train set according to claim 1, further comprising:
a main transformer located under a floor of a driving car included in the cars;
an electric power supply circuit that supplies electric power from the electric power bus line to the main transformer; and
second circuit breaking equipment that is located in an attic space between a roof and ceiling of the driving car and interrupts a current flowing through the electric power supply circuit.
